(19) United States
(12) Patent Application Publication
(10) Pub. No.: US 2026/0067832 A1
(43) Pub. Date: Mar. 5, 2026

(54) POWER AND LATENCY BASED PRACH SELECTION UNDER ACTIVATED ADDITIONAL RACH OCCASIONS

(71) Applicant: QUALCOMM Incorporated, San Diego, CA (US)

(72) Inventors: Ahmed Attia ABOTABL, San Diego, CA (US); Diana MAAMARI, San Diego, CA (US); Changhwan PARK, San Diego, CA (US)

(21) Appl. No.: 18/817,170

(22) Filed: Aug. 27, 2024

(51) Int. Cl. H04W 52/42; H04W 74/0833

(52) U.S. Cl. CPC H04W 52/42; H04W 74/0833

(57) ABSTRACT

Methods and apparatuses are provided for optimizing the selection of random access channel (RACH) occasions based on power and latency considerations, particularly under conditions where additional RACH occasions are activated to enhance network performance and energy efficiency. A user equipment (UE) receives a RACH configuration indicating a RACH occasion and information activating an additional RACH occasion. The UE selects one of the RACH occasion or the additional RACH occasion for a RACH preamble transmission, based on factors such as preamble transmission power, timing, historical transmission data, maximum number of transmissions, maximum transmission power, and specific RACH configurations or feature groups. The UE then transmits a RACH preamble in the selected occasion. Thus, the disclosed methods and apparatuses enable more efficient and reliable network access by dynamically balancing factors such as power usage and latency, leveraging historical transmission data, and adapting to varying network conditions.

### TECHNICAL FIELD

The present disclosure generally pertains to the field of wireless communication, and more particularly, to methods and apparatuses for optimizing the selection of random access channel (RACH) occasions based on power and latency considerations, particularly under conditions where additional RACH occasions are activated to enhance network performance and energy efficiency.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to receive a random access channel (RACH) configuration indicating a RACH occasion; receive information activating an additional RACH occasion; select one of the RACH occasion or the additional RACH occasion for a RACH preamble transmission, the selection being at least in part based on one or more of a first physical RACH (PRACH) transmission power associated with the RACH occasion and a second PRACH transmission power associated with the additional RACH occasion, or a first time associated with the RACH occasion and a second time associated with the additional RACH occasion; and transmit a RACH preamble in the selected one of the RACH occasion or the additional RACH occasion.

Another innovative aspect of the subject matter described in this disclosure may be implemented in a method for wireless communication performable at a UE. The method includes receiving a RACH configuration indicating a RACH occasion; receiving information activating an additional RACH occasion; selecting one of the RACH occasion or the additional RACH occasion for a RACH preamble transmission, the selection being at least in part based on one or more of a first PRACH transmission power associated with the RACH occasion and a second PRACH transmission power associated with the additional RACH occasion, or a first time associated with the RACH occasion and a second time associated with the additional RACH occasion; and transmitting a RACH preamble in the selected one of the RACH occasion or the additional RACH occasion.

Another innovative aspect of the subject matter described in this disclosure may be implemented in an apparatus for wireless communication, which may be a UE. The apparatus includes means for receiving a RACH configuration indicating a RACH occasion; the means for receiving being further configured to receive information activating an additional RACH occasion; means for selecting one of the RACH occasion or the additional RACH occasion for a RACH preamble transmission, the selection being at least in part based on one or more of a first PRACH transmission power associated with the RACH occasion and a second PRACH transmission power associated with the additional RACH occasion, or a first time associated with the RACH occasion and a second time associated with the additional RACH occasion; and means for transmitting a RACH preamble in the selected one of the RACH occasion or the additional RACH occasion.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a block diagram illustrating an example of a decision-making process for UEs when selecting between baseline random access channel (RACH) occasions (ROs) and additional ROs for RACH preamble transmission during a four-step or two-step random-access operation.

FIG. 5 is a block diagram illustrating an example of a chart depicting a structured approach for selection between baseline ROs and additional ROs using one or more boundaries accounting for differences in power transmission and latency.

FIG. 6 is a block diagram illustrating an example of a selection approach between baseline ROs and additional ROs considering a history of preamble retransmissions in a current RACH procedure.

FIG. 7 is a diagram illustrating an example of a call flow between a base station and a UE incorporating various aspects of the present disclosure.

FIG. 8 is a flowchart of an example method of wireless communication performable at a UE.

FIG. 9 is a diagram illustrating an example of a hardware implementation for an apparatus that is a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In wireless communication systems, random access channel (RACH) procedures are important for allowing user equipment (UE) to establish a connection with the network. Traditional RACH procedures, such as the four-step RACH used in LTE and 5G NR networks, involve multiple steps and specific message exchanges between the UE and the network. These procedures are robust and reliable, making them suitable for a wide range of scenarios, including initial access, handovers, and beam failure recovery. The introduction of the two-step RACH procedure in 5G NR aims to reduce latency and improve efficiency, particularly for applications requiring low latency, such as ultra-reliable low-latency communication (URLLC).

Network Energy Saving (NES) strategies focus on enhancing the efficiency of network operations through dynamic adaptations of common signal or channel transmissions. One important component of NES is the dynamic adaptation of the physical random access channel (PRACH) in the time domain. By dynamically adjusting the PRACH in the time domain, the network can better manage resources, reduce energy usage, and maintain high performance levels. This may involve activation of additional RACH occasions on top of semi-statically configured baseline RACH occasions to align with current network demands and conditions.

However, the activation of additional RACH occasions to enhance network performance and energy efficiency introduces further complexity to the UE in dynamically selecting the most appropriate RACH occasion for RACH preamble transmission based on varying network conditions and UE capabilities. For instance, one of the primary challenges in optimizing RACH procedures is balancing transmission power and latency. Without an effective method for selecting between baseline and additional RACH occasions for RACH preamble transmissions, which occasions may differ in associated powers and latencies, UEs may experience increased latency, inefficient power usage, and potential interference with other network operations. Thus, it would be helpful for UEs to determine the optimal RACH occasion for preamble transmission, considering factors such as transmission power, timing, and, in some cases, historical transmission data.

Therefore, aspects of the present disclosure provide methods and apparatuses for power and latency-based selection of RACH occasions under activated additional RACH occasions. The network may configure UEs to dynamically select between baseline and additional RACH occasions based on transmission power, timing, historical transmission data, or any combination of the foregoing. This approach thus provides for optimized network performance, reduced latency, and enhanced energy efficiency.

Accordingly, various aspects of the subject matter described in this disclosure relate generally to wireless communication systems, and more particularly to methods and apparatuses for optimizing the selection of RACH occasions (RO) based on power and latency considerations. Various aspects specifically relate to a dynamic RO selection process between baseline ROs for non-NES capable UEs and additional ROs activated for NES-capable UEs that balances transmission power and latency to optimize network access and performance. Some aspects relate to the detailed mechanisms and criteria used for the selection process, including differences in PRACH transmission power and timing, historical transmission data, semi-statically configured decision regions, and specific PRACH configurations or feature groups. In various examples, apparatuses and methods are provided in which a UE receives a RACH configuration indicating a RACH occasion and receives information activating an additional RACH occasion. The UE selects one of the RACH occasion or the additional RACH occasion for a RACH preamble transmission, the selection being at least in part based on one or more of a first PRACH transmission power associated with the RACH occasion and a second PRACH transmission power associated with the additional RACH occasion, or a first time associated with the RACH occasion and a second time associated with the additional RACH occasion. The UE then transmits a RACH preamble in the selected one of the RACH occasion or the additional RACH occasion.

Thus, particular aspects of the subject matter described in this disclosure may be implemented to realize one or more potential advantages. For example, the disclosed methods and apparatuses may optimize network performance, reduce latency, and enhance energy efficiency in various aspects. In some aspects, the selection is based at least in part on a first difference between the first PRACH transmission power and the second PRACH transmission power, and a second difference between the first time and the second time, allowing for a more precise and context-aware decision-making process. In other aspects, the first PRACH transmission power is a first actual transmission power of the apparatus or a first calculated transmission power of the apparatus that is different than the first actual transmission power, and the second PRACH transmission power is a second actual transmission power of the apparatus or a second calculated transmission power of the apparatus that is different than the second actual transmission power, providing flexibility in power management. Additionally, the selection criteria may include scenarios where the RACH occasion is selected based on the first PRACH transmission power being greater than the second PRACH transmission power and the first time being lesser or greater than the second time, or where the additional RACH occasion is selected based on similar criteria, ensuring that the most suitable RACH occasion is chosen under varying conditions.

Further, the UE may obtain a configuration indicating a RACH occasion decision region, including a boundary defined by differences in PRACH transmission power and timing, which can be semi-statically configured or based on a fixed dataset. This configuration aids in making informed decisions about RACH occasion selection. Moreover, the inclusion of historical transmission data in the decision-making process allows for adaptive adjustments based on past performance, further enhancing the likelihood of successful transmissions. For instance, the selection may be based on the history of RACH preamble transmissions, considering factors such as the maximum number of preamble transmissions previously sent or the maximum transmission power previously reached. This historical context helps in avoiding repeated failures and optimizing the selection process. Moreover, the selection process can be tailored based on a PRACH configuration or a feature group associated with the RACH occasion and the additional RACH occasion, allowing for customization based on specific network requirements and UE capabilities. By dynamically selecting the optimal RACH occasion based on power and latency considerations, UEs can achieve more efficient and reliable network access. This approach ensures that UEs can effectively balance power usage and latency, leading to improved overall network efficiency and user experience.

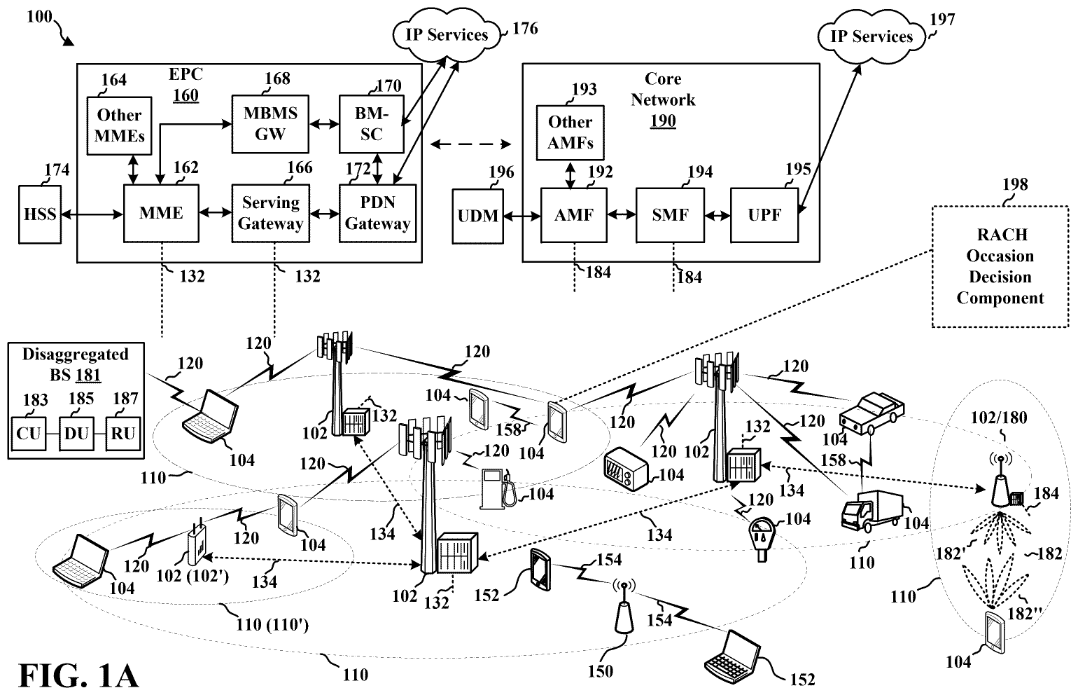

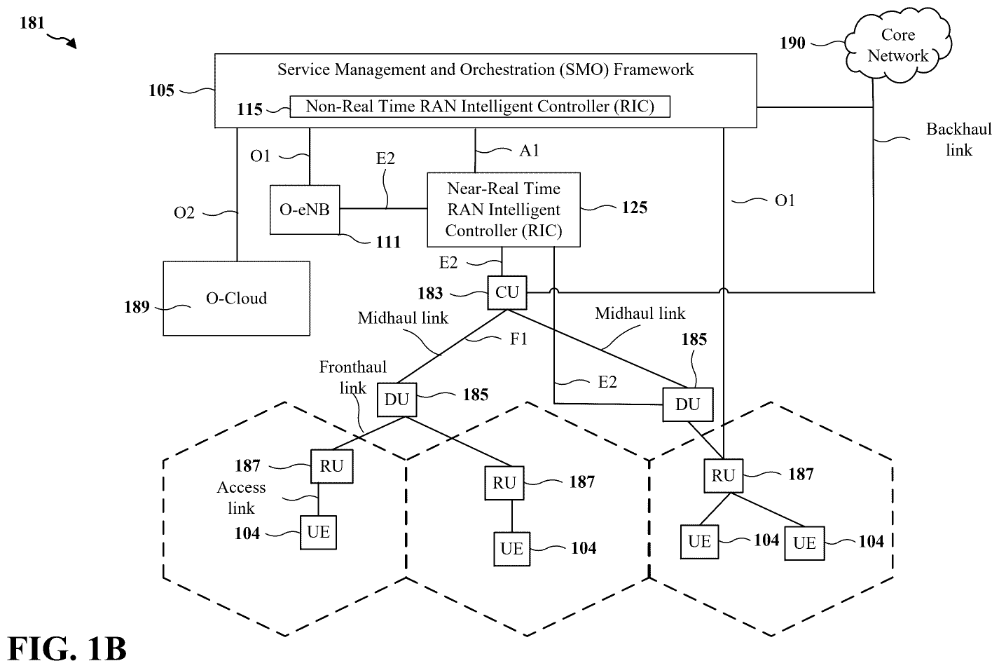

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), cNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUS)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-CNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a RACH occasion decision component 198 that is configured to receive a random access channel (RACH) configuration indicating a RACH occasion; receive information activating an additional RACH occasion; select one of the RACH occasion or the additional RACH occasion for a RACH preamble transmission, the selection being at least in part based on one or more of a first physical RACH (PRACH) transmission power associated with the RACH occasion and a second PRACH transmission power associated with the additional RACH occasion, or a first time associated with the RACH occasion and a second time associated with the additional RACH occasion; and transmit a RACH preamble in the selected one of the RACH occasion or the additional RACH occasion.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

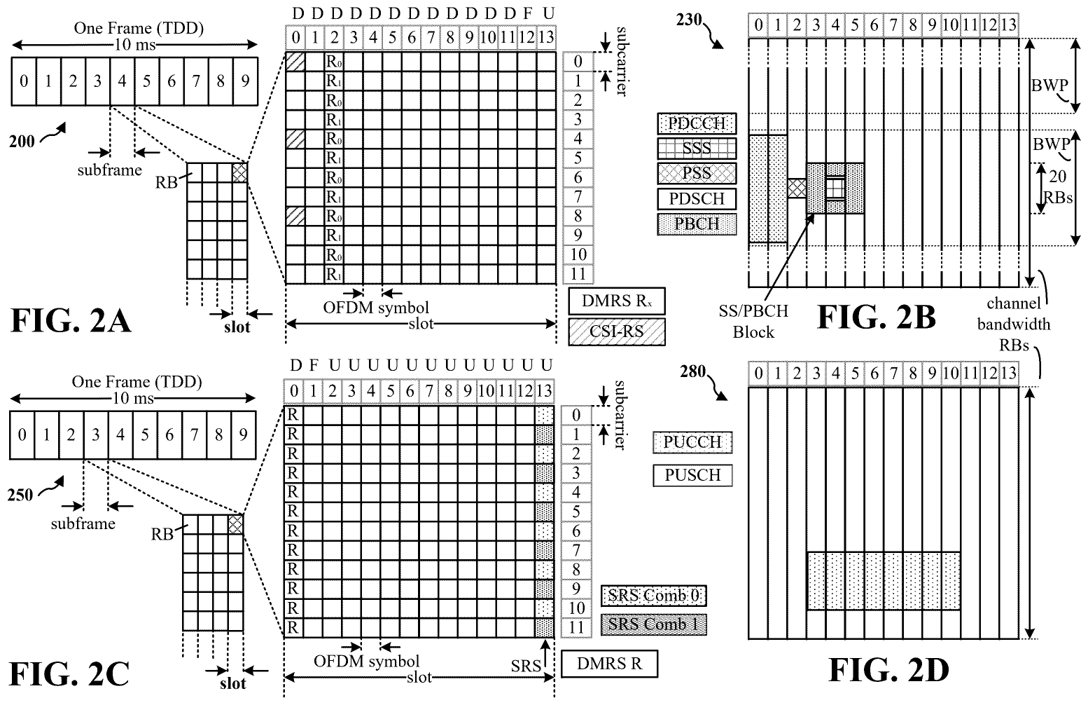

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

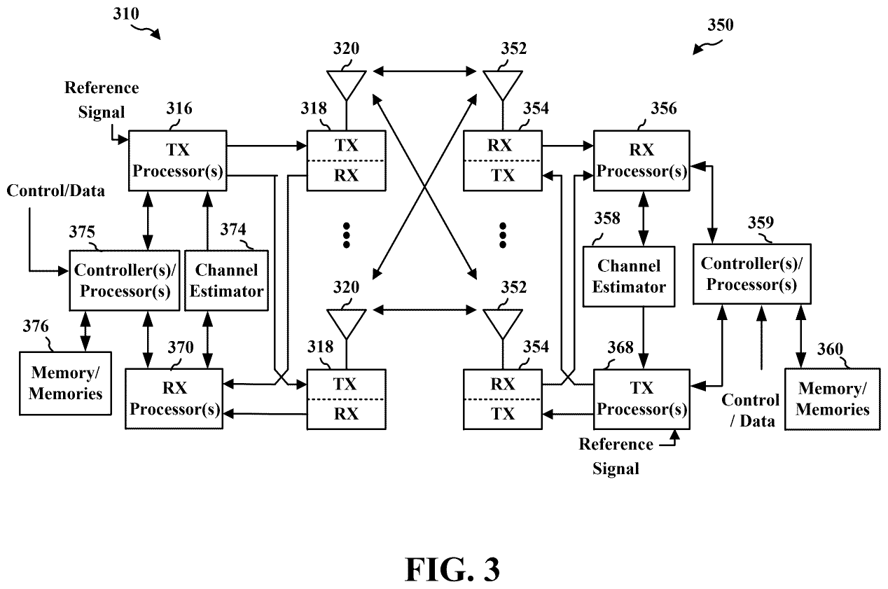

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer).

The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with RACH occasion decision component 198 of FIG. 1A.

The Random Access Channel (RACH) procedure is an important aspect of cellular communication systems, enabling UEs to establish a connection with the network. There are two primary types of RACH procedures: four-step RACH and two-step RACH.

The four-step RACH procedure is the traditional method used in LTE and 5G NR networks. It involves four distinct steps, each with specific messages exchanged between the UE and the network. This method is robust and reliable, making it suitable for a wide range of scenarios, including initial access, handovers, and beam failure recovery. The procedure begins with the UE initiating the RACH process by transmitting a preamble on the physical random access channel (PRACH). The preamble is a short, unique sequence that helps the network identify the UE and measure the timing of the transmission. The preamble is selected from a set of predefined sequences, and its transmission power is determined based on various factors.

Upon receiving the preamble, the base station responds with a random access response (RAR) message. This message is sent on the physical downlink control channel (PDCCH) and includes several pieces of information, including for example, a timing advance (TA) command instructing the UE to adjust its transmission timing to align with the network's timing, a temporary cell radio network temporary identifier (C-RNTI) assigned to the UE for the duration of the RACH procedure, an uplink grant providing the UE with the resources needed for the next uplink transmission, and a power control command to adjust the UE's transmission power for subsequent messages.

The UE then uses the uplink grant provided in the RAR to transmit the third message, which typically includes a radio resource control (RRC) connection request. This message is sent on the physical uplink shared channel (PUSCH) and contains the UE's identity and any additional information required by the network. The network uses this message to authenticate the UE and allocate the necessary resources for the connection. The final step involves the network sending a contention resolution message to the UE. This message is sent on the PDCCH and includes the UE's C-RNTI, confirming the successful completion of the RACH procedure. If multiple UEs transmitted the same preamble, this step resolves any contention by identifying the specific UE that will be granted access.

The two-step RACH procedure is a more recent development, introduced in 5G NR to reduce latency and improve efficiency in certain scenarios. It combines some of the steps from the four-step RACH procedure, making it faster and more suitable for applications requiring low latency, such as ultra-reliable low-latency communication (URLLC). The UE initiates the two-step RACH procedure by transmitting message A (msgA), which combines the preamble and the RRC connection request into a single message. This message is sent on the PRACH and includes the UE's identity and any additional information required by the network. The transmission power and timing of msgA are determined similarly to the preamble in the four-step procedure. Upon receiving msgA, the base station responds with Message B (msgB), which combines the RAR and the contention resolution message of the four-step RACH procedure.

The UE may transmit the preamble in four-step RACH or two-step-RACH using a transmission power determined under PRACH power control. For instance, the UE may determine the transmission power for PRACH, denoted as P (PRACH), based on several parameters and conditions specific to the active uplink bandwidth part (BWP) of a carrier in the serving cell. For example, the UE may calculate the PRACH transmission power according to the following formula (1):

$${P}_{\{ {PRACH}_{\{ b , f , c \}} \}} ( i ) = min [ {P}_{\{ {CMAX}_{\{ f , c \}} \}} ( i ) , {P}_{\{ {PRACH}_{\{ {Target}_{\{ f , c \}} \}} \}} + {PL}_{\{ b , f , c \}} ] \qquad ( 1 )$$

where P_{{CMAX{fc}}}(i) is the UE-configured maximum output power for the carrier f of the serving cell C within a transmission occasion i, and

$${P}_{\{ {PRACH}_{\{ {Target}_{\{ f , c \}} \}} \}}$$

represents the PRACH target reception power provided by higher layers. The path loss PL_{{b,f,c}} for the active UL BWP b of carrier f may also be factored into the calculation. With respect to the PRACH target reception power, this target power may be set or adjusted based on several factors: first, the initial preamble received target power, denoted as preambleReceivedTargetPower; second, an adjustment factor Delta PREAMBLE; third, a preamble power ramping counter, which increments the power by a predefined step size

$${PREAMBLE}_{{POWER}_{{RAMPING}_{STEP}}}$$

each transmission attempt; and fourth, an additional power offset for two-step RACH POWER_OFFSET_2STEP_RA. These adjustments allow the UE to dynamically adapt its transmission power after each RACH transmission attempt to achieve the desired reception quality at the base station, considering the varying path loss conditions and attempting to avoid excessive power usage.

Excessive power usage may be further avoided through network energy saving (NES), which is focused on enhancing the efficiency of network operations through dynamic adaptations of common signal or channel transmissions. One important component of NES is the dynamic adaptation of the Physical Random Access Channel (PRACH) in the time domain. By dynamically adjusting the PRACH in the time domain, the network can better manage resources, reduce energy usage, and maintain high performance levels. This may involve, for example, fine-tuning the timing of PRACH transmissions to align with current network demands and conditions.

Other significant aspects of NES, in connection with the adaptation of common signaling or channel transmissions, includes synchronization signal blocks (SSBs), PRACH in the spatial domain, and paging occasions. In one aspect, the adaptation of an SSB in the time domain may be performed by adjusting its periodicity. By modifying the periodicity of SSB transmissions, the network can achieve a more efficient balance between maintaining synchronization and conserving energy. In another aspect, the adaptation of PRACH resources in the spatial domain may involve non-uniform PRACH resource allocation per SSB. By distributing PRACH resources in a non-uniform manner, the network can potentially enhance its spatial efficiency, leading to better resource utilization and energy savings. In a further aspect, the adaptation of paging occasions may include confining paging occasions within specific time domains to optimize energy usage without increasing paging latency. This allows the network to efficiently manage paging operations while maintaining prompt response times for UEs. In any of these aspects, including adaptation of PRACH in the time domain, it is important that these adaptations do not negatively impact non-NES capable UEs unless significant benefits are demonstrated. For example, existing PRACH configuration tables may be kept intact. This consideration ensures that the network can remain backward compatible while still achieving energy savings and performance improvements.

Furthermore, with respect to the adaptation of common signals and channels, particularly PRACH in the time domain for NES-capable UEs, the adaptation of PRACH may support additional PRACH resources for NES-capable UEs. These RACH occasions may be in addition to the baseline PRACH resources already allocated for non-NES capable UEs, if any. This dual allocation may allow for NES-capable UEs to utilize both the additional PRACH resources and the baseline PRACH resources designated for non-NES capable UEs.

This approach may also enhance the efficiency and flexibility of PRACH resource utilization, catering to both modern and older devices within the network. For example, the network may configure the PRACH with a sparse configuration, such that baseline RACH occasions are spaced out over longer intervals, thereby helping the network save energy by reducing the frequency of PRACH transmissions. Then, to mitigate the risk of increased latency due to this sparse configuration, the network may configure additional PRACH resources. These additional PRACH resources may be configured semi-statically, and the network may activate them dynamically when needed to reduce latency. For instance, the configuration of additional PRACH resources may be provided through semi-static signaling, and the network may activate additional PRACH resources either through dynamic activation or semi-static activation. Potentially, there may be an overlap between the additional PRACH resources for NES-capable UEs and the baseline PRACH resources for non-NES capable UEs.

The additional PRACH resources or RACH occasions may be semi-statically configured in a RACH configuration such as RACH-ConfigCommon, rach-ConfigGeneric, or other RRC-configured PRACH configuration. RACH-ConfigCommon at least may include various PRACH configuration parameters that are important for optimizing PRACH operations, including, for example, a power ramping step and a preamble received target power that may be applied to PRACH power control. These parameters may help the UE to determine the power levels at which the UE transmits PRACH signals in an associated baseline or additional RACH occasion. For example, the power ramping step may define the incremental increase in transmission power after each failed attempt, ensuring that the UE gradually increases its power to improve the chances of successful transmission. The preamble received target power may be applied to set the target power level that the UE aims to achieve for its PRACH transmissions in PRACH power control.

Separate instances of these or other RACH configuration parameters may be configured for baseline and additional ROs. For instance, a PRACH configuration may include distinct settings for the power ramping step, maximum transmission power, or other related parameters for additional ROs. This separation allows the UE to optimize its transmissions for both baseline ROs and additional ROs, considering any specific requirements or constraints of each type. For example, the PRACH configuration may include a separate power ramping step for additional ROs, allowing the UE to increment its transmission power differently compared to baseline ROs. Similarly, a maximum transmission power parameter for additional ROs may allow the UE to not exceed different allowable power levels for additional ROs than for baseline ROs, preventing interference with non-NES capable UEs using the baseline ROs and optimizing energy usage.

When a UE attempts to access a network that provides for adaptation of the PRACH in the time domain, particularly via semi-static configuration of additional RACH occasions (ROs) which may be activated whenever the network decides, the UE may decide whether to use one of the baseline ROs or one of the additional ROs when these additional ROs are active. The decision may be based on which option reduces latency the most. Latency is a significant concern because it is generally preferable for the UE to send the PRACH as soon as possible to minimize delays. Reduced latency is important for maintaining the quality of service and ensuring that the network can respond promptly to the UE's requests.

However, another significant factor is the preamble transmission power over the additional ROs, which may differ from the transmission power over the baseline ROs. For example, the PRACH power control over the baseline ROs may be different from the power control over the additional ROs. For instance, in a typical PRACH operation, if the UE makes one transmission and fails, the UE increments its power and tries again until it succeeds, up to a maximum transmission power. While this process may be straightforward for non-NES capable ROs, in additional ROs, there may be another limit on the maximum power that can be used for transmission. Moreover, the additional ROs may not be accessible by non-NES capable UEs, and so NES-capable UEs' transmission over these additional ROs may cause unexpectedly high interference to non-NES capable UEs. Therefore, for transmission of preambles in additional ROs, the network may configure the UE to transmit with smaller power or have a smaller maximum limit to their transmission power over the additional ROs than for baseline ROs.

As a result, it would be helpful for the network to regulate the selection between baseline ROs and additional ROs based on transmission power and latency. More particularly, it would be helpful for the network to allow a UE to make informed decisions about which RO to use for its preamble transmission, namely a baseline RO or an additional RO, considering their different power requirements and the importance of minimizing latency. Such regulation would allow the UE to optimize its transmissions with a balance between efficient power usage and latency reduction while avoiding collisions.

Accordingly, aspects of the present disclosure provide for the network to configure UEs to consider both transmission power and latency when selecting between a baseline RO and an additional RO for RACH preamble transmission, where the additional RO is semi-statically configured and semi-statically or dynamically activated through PRACH time domain adaptation. For example, if the UE is limited in transmission power and determines that transmitting over an additional RO with low power may likely fail, the UE may select to wait and transmit over a baseline RO with higher power. This decision may allow the UE to avoid wasting energy on a transmission that is likely to fail. Conversely, if the baseline RO is the one that minimizes latency but requires higher power, the UE may decide to wait a bit longer until the time of an additional RO. This balance between latency and power control may allow the UE to optimize PRACH transmissions and ensuring efficient network operation.

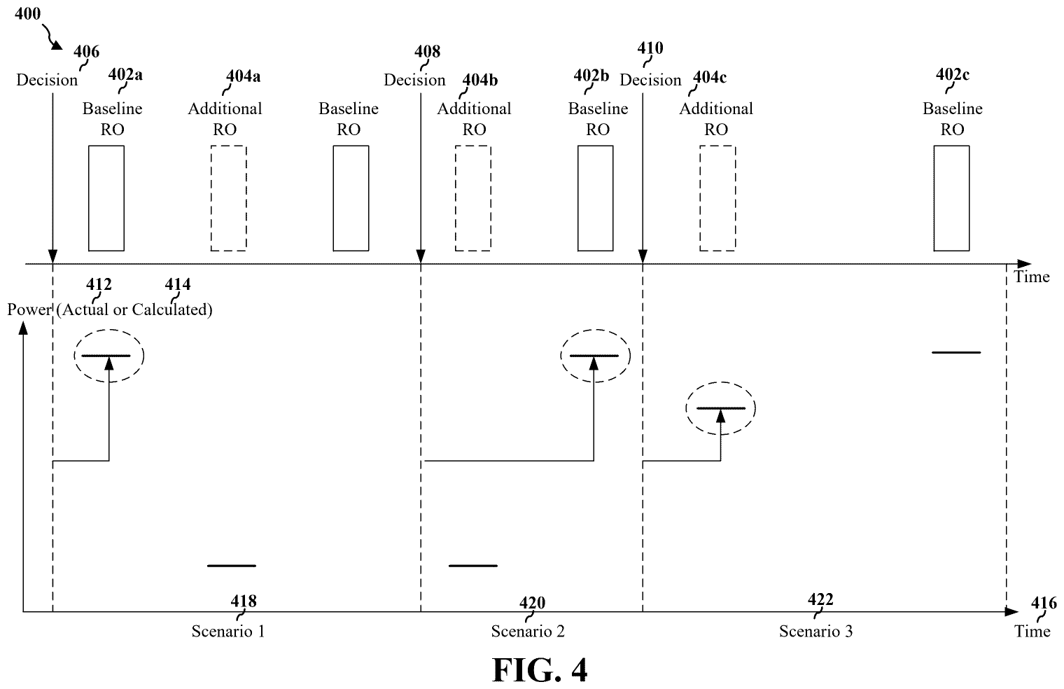

FIG. 4 illustrates an example 400 of a decision-making process for UEs when selecting between baseline ROs 402a, 402b, and 402c and additional ROs 404a, 404b, and 404c for RACH preamble transmission during a four-step or two-step random-access operation. This process is particularly relevant for NES-capable UEs, which are designed to optimize network performance and energy efficiency. The illustrated example outlines different scenarios for UE selection between additional and baseline ROs based on PRACH transmission power and latency. After additional ROs are activated, when a NES-capable UE intends to transmit a RACH preamble, the UE may make a decision 406, 408, 410 whether to transmit over the additional ROs 404 or the baseline ROs 402. This decision 406, 408, 410 may be influenced by several factors.

First, a PRACH transmission power to be applied to an RO may be considered. This power may include either an actual transmission power 412 or a calculated transmission power 414. The calculated transmission power 414 may be, for example, the UE-configured maximum output power for PRACH derived in aforementioned formula (1), while the actual transmission power 412 may be a power that the UE applies for its transmission which is different than or offset from the UE-configured maximum output power. The offset may be applied, for example, to account for other transmissions across multiple component carriers (CCs). For instance, for connected UEs with multiple CCs, a UE may determine to prioritize power across different CCs. For example, if the UE is transmitting PRACH on one CC and PUSCH on another CC, it may reduce the calculated PRACH transmission power slightly on the former CC to accommodate the transmission on the latter CC.

After determining whichever power 412, 414 the UE intends to use, the UE may evaluate one of the actual transmission power 412 or the calculated transmission power 414 to be applied at a time for both the baseline RO 402 and the additional RO 404. This evaluation may help the UE determine which RO is more energy-efficient and likely to succeed in transmission. The UE may select to transmit between additional ROs 404 and baseline ROs 402 based on the PRACH transmission power to be applied to the respective ROs, either the actual transmission power 412 or the calculated transmission power 414. The UE may make the informed, decision 406, 408, 410 by considering the transmission power to be applied over the baseline RO 402 and the additional RO 404.

Second, a latency or delay associated with an RO may be considered. The UE may consider a time 416 it takes to transmit over the baseline RO 402 and the additional RO 404. Lower latency or a shorter value for time 416 is generally preferable as it ensures quicker access to the network, which is important for maintaining high-quality service and reducing delays in communication. However, the latency or delay corresponding to the baseline RO 402 and the additional RO 404 is here a factor for the UE's process of making the informed, decision 406, 408, 410. The UE may weigh the power of the baseline RO 402 and the additional RO 404 against the latency to determine the optimal choice of RO.

To illustrate these concepts, FIG. 4 depicts examples of different scenarios 418, 420, 422. In scenario 418, the UE may transmit a preamble at an earlier time and with higher power over the baseline RO 402a than over additional RO 404a. In this case, the UE may select the baseline RO 402a for the preamble because it offers both lower latency and higher transmission power, making it the more efficient choice. Thus, the UE may evaluate both power and timing to make an optimal decision of RO. The decision 406 in scenario 418 is straightforward in this case, since the earliest RO that allows transmission with high power is what the UE may consider to be the better choice.

However, in scenario 420, the UE faces a different situation. If the UE selects the additional RO 404b in this case, it can transmit earlier but with significantly smaller power than the baseline RO 402b. This choice may cause high interference and delay to non-NES capable UEs transmitting at the time of the baseline RO 402b. But here, the delay to the baseline RO 402b is not too significant, and so the UE may decide to wait and transmit over the baseline RO 402b instead. Thus, by considering the trade-off between latency and power, the UE may select the baseline RO 402b in decision 408, thereby avoiding causing interference and improving the likelihood of successful transmission. The additional RO 404b, while offering a benefit in terms of latency, in this scenario 420 presents a disadvantage in terms of power, which thus leads the UE to select the baseline RO 402b in this case.

Yet, in scenario 422, although the power associated with baseline RO 402c is again greater than additional RO 404c, here the difference in power between the additional RO 404c and the baseline RO 402c is not too significant, and selecting the additional RO 404c would save significant latency compared to the additional RO in scenario 420. In this case, the UE may select to transmit in the additional RO 404c because the latency savings outweigh the slight difference in transmission power. Moreover, the UE may determine that reducing latency may be more beneficial than optimizing for transmission power alone in this scenario based on other factors. Thus, in decision 410, the UE may select the additional RO after balancing the benefits of reduced latency with the potential drawbacks of lower transmission power.

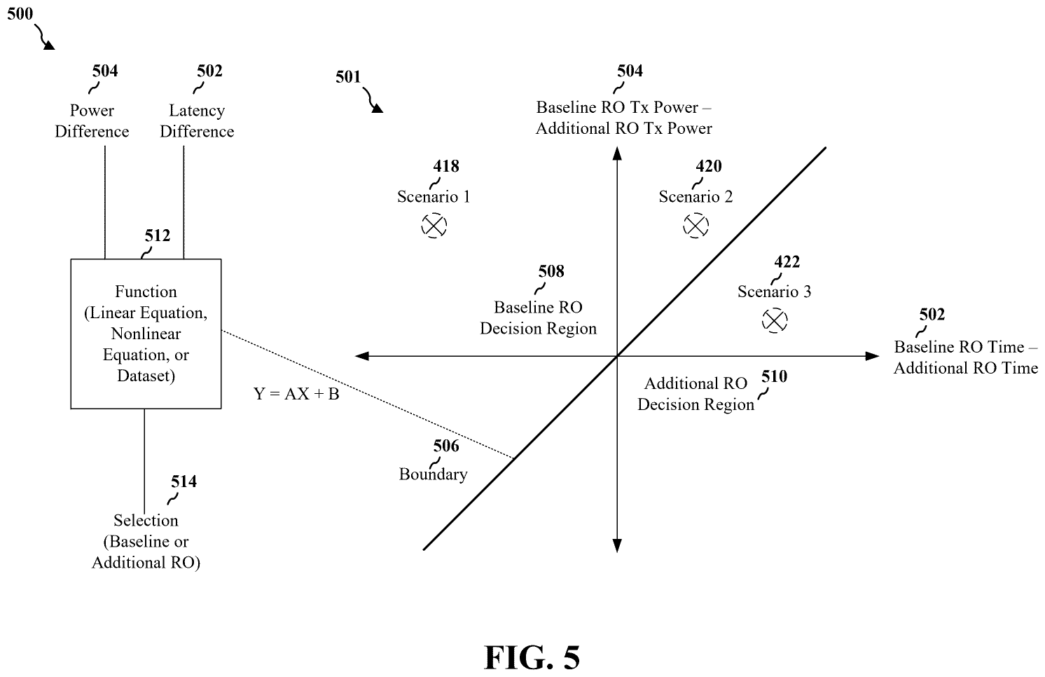

FIG. 5 illustrates an example 500 of a chart 501 depicting a structured approach for selection between baseline ROs 402 and additional ROs 404 using one or more boundaries accounting for differences in power transmission and latency. The UE may be configured with specific boundaries that define the differences in transmission power and latency between baseline ROs 402 and additional ROs 404. These boundaries may assist the UE in making informed decisions about which RO to use for its preamble transmission, for example when performing the decision 406, 408, 410 in FIG. 4, thereby balancing efficient power usage with minimized latency.

Here, chart 501 is shown with an X-axis and a Y-axis. The X-axis represents a time difference 502 between a baseline RO 402 and an additional RO 404, while the Y-axis represents a difference 504 in transmission power between that baseline RO 402 and that additional RO 404. If the time from decision 406, 408, 410 to baseline RO 402 is greater than the time from decision to additional RO 404, the value on the X-axis is positive, indicating that the baseline RO 402 comes later in time than the additional RO 404. Thus, moving to the right on the X-axis of chart 501 means the baseline RO 402 gets more delayed compared to the additional RO 404. On the Y-axis, a positive value indicates that the UE can transmit with higher power in the baseline RO 402 than in the additional RO 404. Thus, moving up on the Y-axis of chart 501 gives a benefit to the baseline RO 402 in terms of power, while moving left on the X-axis of chart 501 gives a benefit to the baseline RO 402 in terms of timing.

The optimal line or boundary 506 in chart 501 defines the best decision or selection strategy for the UE, allowing it to compare latency and power to decide whether to use the baseline RO 402 or the additional RO 404. For example, time differences 502 and power differences 504 to the left of the boundary 506 on chart 501 may indicate a decision region 508 where the UE selects the baseline RO 402, such as illustrated and described with respect to scenario 418 at decision 406 in FIG. 4, while time differences 502 and power differences 504 to the right of the boundary 506 on chart 501 may indicate a decision region 510 where the UE selects the additional RO 404, such as illustrated and described with respect to scenarios 420, 422 at decisions 408, 410 in FIG. 4. Thus, if the UE determines at a decision time that the additional RO 404 minimizes latency but has a lower transmission power, it may choose the additional RO 404 if the power is sufficient such as illustrated and described with respect to scenario 422 in FIG. 4. Conversely, if the latency is not a significant concern, the UE may at a decision time choose the baseline RO 402 for its higher transmission power such as illustrated and described with respect to scenario 420 in FIG. 4.

One approach to defining these decision regions 508, 510 is through the definition of a function 512, such as a linear equation, non-linear equation, or a dataset for the chart 501. For instance, in the illustrated example of FIG. 5, chart 501 may be defined by a linear equation Y=AX+B, where Y represents the difference 504 in transmission power between the baseline RO 402 and the additional RO 404, X represents the time difference 502 between the baseline RO 402 and the additional RO 404, A is a configured slope, and B is a configured y-intercept. As previously described, a positive value for X indicates that the baseline RO 402 comes later in time compared to the additional RO 404, while a positive value for Y indicates that the baseline RO 402 is associated with higher preamble transmission power compared to the additional RO 404.

By defining function 512 such as the linear equation depicted in chart 501 of FIG. 5, the network may configure decision regions 508, 510 that guide the UE in selecting the most appropriate RO for a preamble transmission based on the current conditions. For example, if the decision regions 508, 510 are defined using a linear equation such as Y=AX+B, the x-intercept, y-intercept, the slope parameters, or any combination of the foregoing may be semi-statically configured. Thus, the network may adjust these parameters based on real-time conditions, providing a dynamic and responsive approach to PRACH adaptation. The linear equation in this case may define a straightforward decision boundary such as boundary 506, allowing the UE to easily determine whether to use the baseline RO 402 or the additional RO 404 based on an actual or calculated transmission power and latency.

Alternatively, for more complicated functions such as nonlinear equations, the decision regions 508, 510 may be defined using a dataset, such as a table of range values for Y and X, with corresponding selection criteria. For example, function 512 may be a defined table including one column of X values or ranges of X values, another column of Y values or ranges of Y values, and decision region 508 or 510 as a result corresponding to each row of X and Y values or ranges of values. The dataset may indicate the UE to apply decision region 508 for certain values or ranges of X and Y and to apply decision region 510 for other values or ranges of X and Y in chart 501. This dataset may either be fixed or semi-statically indicated, providing a flexible approach to decision-making. By using a dataset, the network may offer a range of possible scenarios, each with predefined selection criteria, allowing the UE to make decisions based on the specific conditions it encounters.

Thus, the UE may perform a selection 514, for example at decision 406, 408, or 410, of baseline RO 402 or additional RO 404 depending on whichever RO offers a better trade-off between power and latency at a given decision time. The base station may configure the UE with boundaries of differences 502, 504 in power transmission and latency between the additional ROs 404 and baseline ROs 402, assisting the UE in the process of selection 514. In the illustrated example, the boundary 506 in chart 501 represents linear, decision regions 508, 510 that may be determined. For example, the network may configure the UE with function 512 that includes a specific slope and x-intercept or y-intercept that is semi-statically or dynamically configured, which parameters may indicate the ranges of power difference 504 and latency difference 502 in which decision regions 508, 510 are determined. In other examples, the base station may configure a non-linear function resulting in multiple boundaries 506 indicating non-linear, decision regions for selection 514. Alternatively, the UE may obtain from memory or in a semi-static configuration a dataset such as a table with ranges of values for Y and X indicating corresponding decisions for selection 514. If the power and latency differences fall within a specific range in the dataset, the UE may select the baseline RO 402, while if these differences fall within a different range, the UE may instead select the additional RO 404.

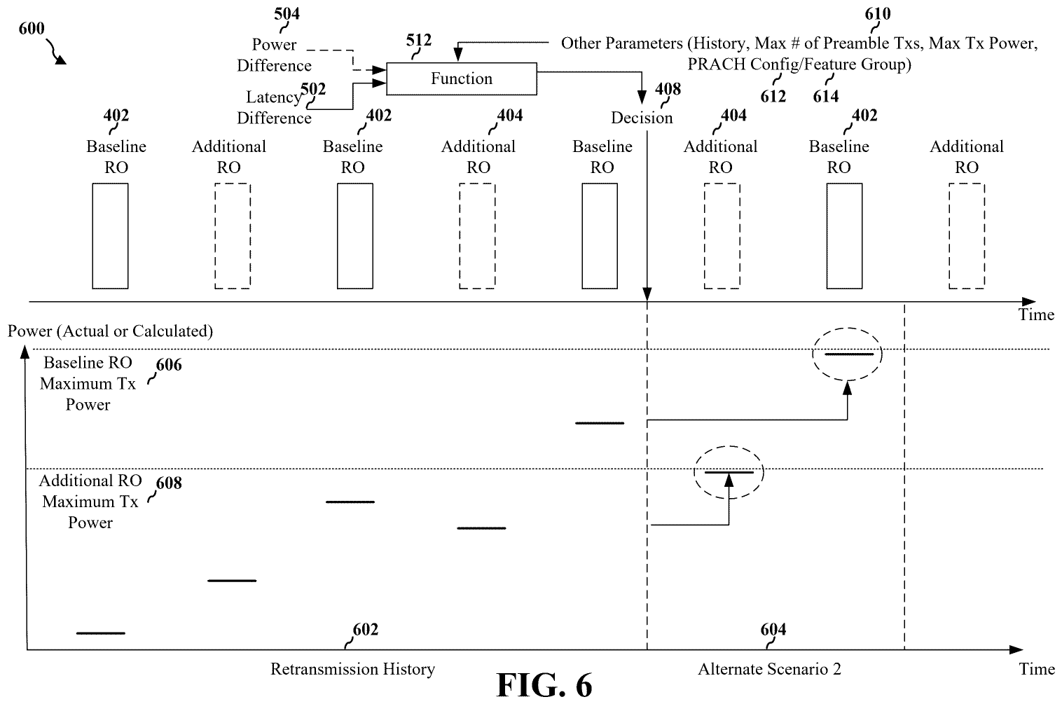

FIG. 6 illustrates an example 600 of a selection approach between baseline ROs 402 and additional ROs 404 considering a history 602 of preamble retransmissions in a current RACH procedure. When the UE selects between additional ROs 404 and baseline ROs 402, it may account for the power levels of previous transmissions. For example, if the UE's first transmission is a baseline RO, the second is also a baseline RO, but the third and fourth transmissions are additional ROs, the UE may to consider this history 602 in its process of selection 514. If both the additional RO power and the baseline RO power are respectively higher than the corresponding last RO transmission power, such as illustrated in the example of FIG. 6, the UE may ignore the difference in power between the baseline RO 402 and the additional RO 404 at decision 408 and make the selection 514 solely based on latency. Thus, in scenario 604, the UE may select the earlier, additional RO 404 rather than baseline RO 402, in contrast to the previously discussed, scenario 420, even if the power associated with additional RO 404 and baseline RO 402 may not have changed between the scenarios. This approach allows the UE to prioritize reducing latency when the power levels are already sufficiently high, thereby optimizing the overall efficiency of the transmission process.

Moreover, the UE may apply a power increment process when it transmits RACH preambles. For example, if a maximum transmission power 606 for the baseline RO 402 and a maximum transmission power 608 for the additional RO 404 are both higher than the last attempt's transmission power, the UE may increment its transmission power in the next RACH occasion since it has not yet reached any maximum limits. This incrementing is illustrated, for example, in history 602 of FIG. 6. In such cases, the UE may not consider power differences 504 between the ROs 402, 404 and may focus on latency differences 502 instead when selecting ROs during history 602. However, if the UE continues to transmit preamble attempts and reaches a point where it may end up choosing between a baseline RO with a higher power level and an additional RO with a lower power level, such as in scenario 604, the UE may end up decrementing its transmission power upon selecting the additional RO, which deviates from the traditional, incrementing PRACH process. Therefore, in this example, the UE may start considering power differences only when it approaches the maximum transmission power 606, 608 for either a baseline RO or an additional RO. For example, at scenario 604, the UE may select the baseline RO 402 in a different example since it includes the higher power.

Thus, when the UE has not reached the maximum transmission power 606 or 608 for a particular type of RO (baseline or additional) and keeps failing its preamble attempts, it may continue to increase its transmission power over time. In such scenarios, the UE may focus on latency differences 502 rather than power differences 504 in its selections 514, since the power differences 504 will not be substantial. However, once the UE reaches the maximum power 608 for the additional RO, a significant difference in transmission power between the baseline RO 402 and the additional RO 404 may occur. Thus, the UE may now start considering power differences 504 in its selection. If the difference 504 in power is substantial, the UE may evaluate whether it is worth decreasing power by selecting the additional RO 404 contrary to typical incrementing PRACH procedures. The decision to decrease power may still be made if it significantly improves latency; otherwise, the UE may opt for the baseline RO 402.

Additionally, other parameters are not precluded from consideration. For instance, a maximum number of transmissions 610 on a given type of RO (baseline or additional), the maximum transmission power 606, 608, or any combination of these or other parameters may be considered. The maximum number of transmissions 610 for a baseline RO or an additional RO may be considered to ensure that the UE may not exceed the allowable number of transmissions, which could lead to inefficiencies and increased collision rates. Moreover, if the maximum transmission power 606, 608 over a given RO type is reached, the UE may fall back to the other PRACH occasion type. For instance, as illustrated in another example of scenario 604, even if the UE would otherwise from function 512 or history 602 select additional RO 404 for its preamble, the UE in this case may decide to select baseline RO 402 as a fallback RO for its preamble, since maximum transmission power 608 for additional RO 404 has already been reached in history 602. This fallback mechanism may particularly be useful in scenarios where the former (non-fallback) RO type is experiencing exceedingly high collision rates. By switching to the latter (fallback) PRACH occasion type, the UE may avoid further collisions and improve the chances of successful transmission. This dynamic approach to selecting ROs based on the history 602 of retransmissions and current power levels helps enhance the overall performance and reliability of the network.

Thus, even if the difference in transmission power is small, the UE may or may not consider it in its process of selection 514 depending on other factors. For instance, if the additional RO power and the baseline RO power are both higher than their previous transmission power, the UE may ignore the power difference based on the assumption that the difference is small. The power difference 504 is minimal, so the UE may ignore it and focus on latency. However, if the maximum transmission power is reached, the UE may consider the power difference, as it is likely to be significant. Alternatively or additionally, if the power difference is significant, the UE may evaluate both power and latency. Such non-linear decision regions may be visualized through a modification of chart 501 to include a range where small power differences 504 may be ignored in the decision process and thus only latency is considered, while large power differences 504 may be considered outside this range in addition to latency in the decision process. Thus, the UE may make informed decisions based on both power and latency, optimizing its transmissions for efficiency and reliability.

In another example, the selection 514 process may vary based on the specific PRACH use case. For example, in beam failure recovery scenarios, the UE may ignore the power condition and at decision 408 select to transmit in the earliest available RO, considering latency difference 502 but not power difference 504. Thus, the boundary 506 of selection illustrated in FIG. 5 may be different for each PRACH configuration 612 or feature group 614. By tailoring the selection criteria to different PRACH use cases, the network may allow the UE to make the most appropriate decision for each situation. This flexibility provides for optimized network performance and allows the UE to respond effectively to different types of network conditions and requirements.

Thus, the decision criteria, including any combination of latency difference 502, power difference 504, or other parameters such as illustrated in FIG. 6, may vary depending on the use case. For instance, the criteria for PRACH in beam failure recovery, which may exclude power difference 504 in the aforementioned example, may be different from those for system information requests, initial access, or mobility, which may include other parameters in the decision 408 process. For example, each use case may have different UE priorities, such as focusing solely on latency difference 502 for system information requests or considering power difference 504 more heavily in contention-based random access scenarios. The boundary 506 defined for decision-making may be different, or the criteria may be entirely based on latency or entirely based on power or entirely based on other parameters, depending on the specific use case.

The UE may determine which situation or use case it is in based on the PRACH configuration 612 or feature group 614 associated with the baseline RO 402 or additional RO 404. For example, a PRACH configuration for a preamble to be transmitted in an RO may include one or more parameters indicating whether the UE is performing beam failure recovery, initial access, system information requests, or another use case. This configuration may assist the UE in deciding whether to prioritize power, latency, other criteria, or a combination of any of the foregoing. For example, the inputs to function 512 for decision 408 may change depending on the parameters or PRACH configuration. The feature groups 614 here may refer to groups of configurations that assist in standardizing the decision-making process across different use cases. For example, two-step RACH configurations may be categorized in one feature group, while four-step RACH configurations may be categorized in another feature group. Thus, the inputs to function 512 for decision 408 may change depending on whether the baseline RO 402 or additional RO 404 is associated with two-step RACH, four-step RACH, or some other feature group or group of PRACH configurations. Moreover, within each feature group, there may be different use cases or PRACH configurations such as for beam failure recovery or initial access as described above, each with its own criteria for decision-making.

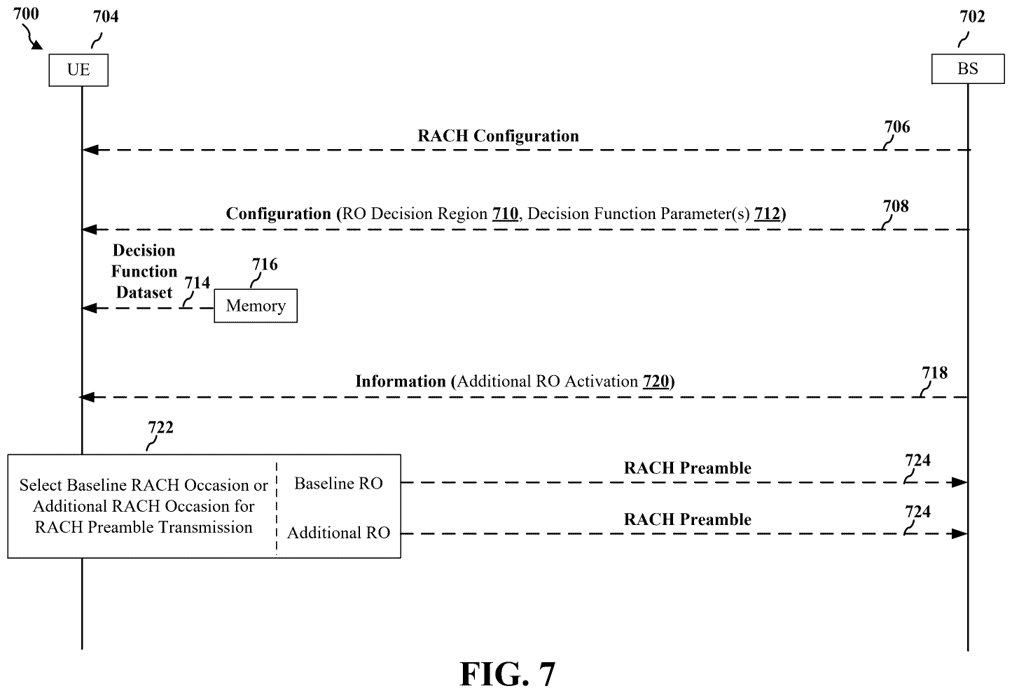

FIG. 7 illustrates an example 700 of a call flow diagram between a base station 702 and a UE 704 illustrating various aspects of the present disclosure. Here, base station 702 may correspond to base station 102, 310, and UE 704 may correspond to UE 104, 350. Initially, the base station 702 may transmit a RACH configuration 706 to the UE 704. The configuration 706 may be, for example, a RACH configuration, such as a PRACH configuration indicating parameters, time-frequency resources, periodicities, or other information for RACH occasions or RACH preambles, or a RRC configuration including or associated with such PRACH configuration. The configuration 706 may be for four-step RACH or two-step RACH. The base station 702 may also transmit a configuration 708 separately from, or integrated with, the RACH configuration 706. The configuration 708 may similarly be, for example, a RACH configuration, such as a PRACH configuration indicating parameters, time-frequency resources, periodicities, or other information for RACH occasions or RACH preambles, or a RRC configuration including or associated with such PRACH configuration. The configuration 708 may likewise be for four-step RACH or two-step RACH. The RACH configuration 706 and the configuration 708 may be the same configuration or separate configurations, one configuration may be within the other configuration, or one configuration may be otherwise associated with the other configuration.

The configuration 706 or 708 may indicate an RO decision region 710, such as baseline RO decision region 508, additional RO decision region 510, or boundary 506 of decision regions 508, 510 in chart 501 of FIG. 5, one or more decision function parameters 712, such as a slope, X-intercept, Y-intercept, or other input or other parameters to function 512 in FIG. 5 or 6, or a combination of any of the foregoing, which assist or allow the UE 704 to make decisions 406, 408, 410 regarding whether to send a RACH preamble transmission in baseline RO 402 or additional RO 404 at a given point in time. Alternatively or additionally, the UE 704 may obtain a decision function dataset 714 from memory 716, such as memory 360 in FIG. 3. The dataset 714 may be, for example, a table of values or ranges of values indicating the RO decision region 710, such as baseline RO decision region 508, additional RO decision region 510, or boundary 506 of decision regions 508, 510 in chart 501 of FIG. 5.

Subsequently, the base station 702 may transmit information 718 to the UE 704. The information 718 may include an additional RO activation 720. For example, information 718 may be a medium access control (MAC) control element (MAC-CE) or downlink control information (DCI) that activates additional ROs 404 configured in a RACH configuration. The information 718, or separate information, may in some cases also indicate the RO decision region 710, decision function parameter(s) 712, or dataset 714, instead of or in addition to configurations 706 or 708.

Based at least in part on the configurations 706, 708 and information 718, at block 722, when the UE intends to transmit a RACH preamble for initial access, beam failure recovery, or other cause, the UE 704 may make a decision such as decision 406, 408, or 410 in FIG. 4 or 6. More particularly, the UE may select either a baseline RO or an additional RO, such as baseline RO 402 or additional RO 404 in FIG. 4 or 6, to send a RACH preamble 724 to the base station 702. The RACH preamble 724 may be a two-step RACH preamble or a four-step RACH preamble. The decision or selection 514 at a given time may be based on the RO decision region 710, decision function parameter(s) 712, dataset 714, or other parameters such as described with respect to FIGS. 4-6. For example, the UE may decide whether to or select to transmit RACH preamble 724 in baseline RO 402 or additional RO 404 based at least in part on one or more of power differences 504, latency differences 502, other parameters, inputs to function 512, other parameters of function 512, history 602 of retransmissions, maximum transmission powers 606, 608, maximum number of preamble transmissions 610, PRACH configurations 612 or feature groups 614, or any combination of the foregoing such as previously described.

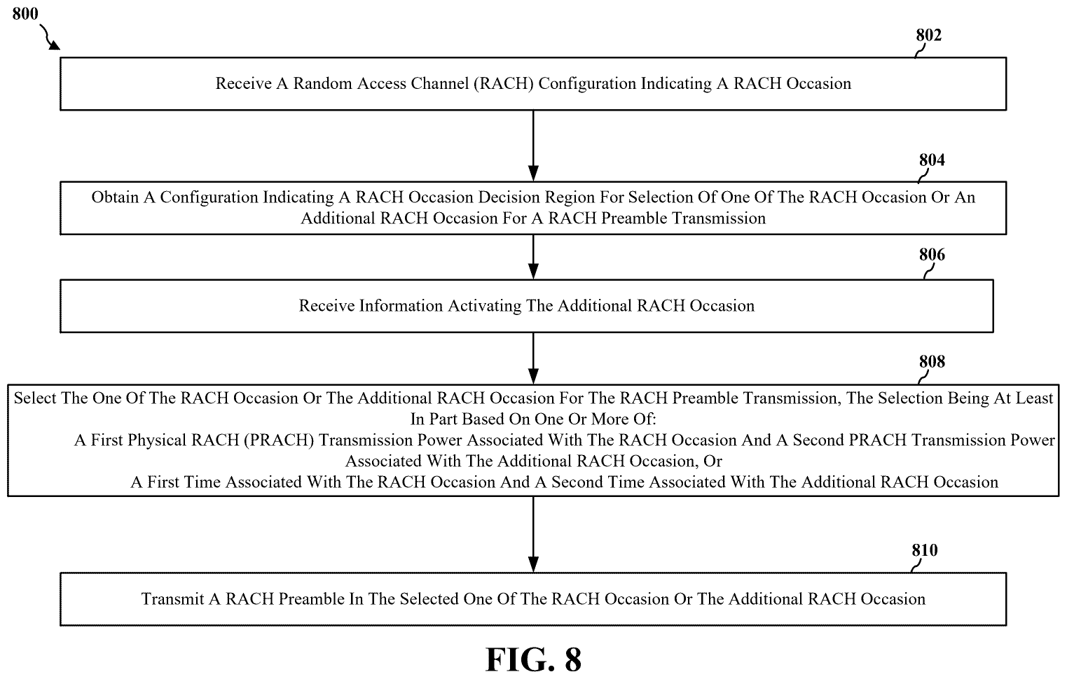

FIG. 8 is a flowchart 800 of an example method or process for wireless communication. The method may be performed by a UE such as the UE 104, 350, or apparatus 902 or its components as described herein. Optional aspects are illustrated in dashed lines. The method allows for the dynamic selection of RACH occasions based on power and latency considerations, particularly under conditions where additional RACH occasions are activated to enhance network performance and energy efficiency.

At block 802, the UE may receive a RACH configuration indicating a RACH occasion. For example, block 802 may be performed by configuration component 940. For instance, referring to the Figures, the controller(s)/processor(s) 359, the RX processor(s) 356, or a combination of these processor(s) of UE 704 may decode, demodulate, and receive via antennas 352, RACH configuration 706 indicating time-frequency resources, a periodicity, or other parameters for baseline ROs 402.

At block 804, the UE may obtain a configuration indicating a RACH occasion decision region for the selection of the one of the RACH occasion or an additional RACH occasion for a RACH preamble transmission. For example, block 804 may also be performed by configuration component 940. For instance, referring to the Figures, the controller(s)/processor(s) 359, the RX processor(s) 356, or a combination of these processor(s) of UE 704 may decode, demodulate, and receive via antennas 352, or the controller(s)/processor(s) 359 may receive from memory 360, configuration 708 indicating the RO decision region 710 in which a certain decision 406, 408, 410 or selection 514 may fall. RO decision region 710 may be indicated, for example, via decision function parameter(s) 712 or decision function dataset 714.

For instance, configuration 708 may indicate the UE to transmit RACH preamble 724 in either baseline RO 402 or additional RO 404 depending on whichever RO decision region 710 the UE determines to apply, as decided based at least in part on power differences 504, latency differences 502, parameter(s) 712, dataset 714, other parameters in FIG. 6, or any combination of the foregoing.

At block 806, the UE may receive information activating an additional RACH occasion. For example, block 806 may be performed by information component 942. For instance, referring to the Figures, the controller(s)/processor(s) 359, the RX processor(s) 356, or a combination of these processor(s) of UE 704 may decode, demodulate, and receive via antennas 352, information 718 activating additional ROs 404, for example via additional RO activation 720.

At block 808, the UE may select one of the RACH occasion or the additional RACH occasion for a RACH preamble transmission. The selection may be based at least in part based on one or more of: a first PRACH transmission power associated with the RACH occasion and a second PRACH transmission power associated with the additional RACH occasion, or a first time associated with the RACH occasion and a second time associated with the additional RACH occasion. For instance, the selection may be based at least in part on a first difference between the first PRACH transmission power and the second PRACH transmission power, and a second difference between the first time and the second time. For example, block 808 may be performed by selection component 944. For instance, referring to the Figures, the controller(s)/processor(s) 359 of UE 704 may, at block 722, select either the baseline RO 402 or additional RO 404 for transmission of RACH preamble 724 at a given time. The selection 514, which may for example be made at decision 406, 408, or 410, may be based at least in part on power differences 504 between the baseline RO 402 and additional RO 404, latency differences 502 between the baseline RO 402 and additional RO 404, or both power differences 504 and latency differences 502.

Finally, at block 810, the UE may transmit a RACH preamble in the selected one of the RACH occasion or the additional RACH occasion. For example, block 810 may be performed by preamble component 946. For instance, referring to the Figures, the controller(s)/processor(s) 359, the TX processor(s) 368, or a combination of these processor(s) of UE 704 may encode, modulate, and transmit via antennas 352, RACH preamble 724 in the baseline RO 402 or additional RO 404 selected for transmission at block 722.

In one example, the first PRACH transmission power may be a first actual transmission power of the UE or a first calculated transmission power of the UE that is different than the first actual transmission power, and the second PRACH transmission power may be a second actual transmission power of the UE or a second calculated transmission power of the UE that is different than the second actual transmission power. For instance, referring to FIG. 4, the powers respectively associated with baseline ROs 402 and additional ROs 404 may be actual transmission powers 412 or calculated transmission powers 414, the latter of which may be different than the actual transmission powers 412.

In one example, the RACH occasion may be selected at least in part based on the first PRACH transmission power being greater than the second PRACH transmission power and the first time being lesser than the second time. For instance, referring to FIG. 4, at decision 406, the UE may select to transmit RACH preamble 724 in baseline RO 402a based on the power differences 504 and latency differences 502 illustrated in scenario 418.

In one example, the RACH occasion may be selected at least in part based on the first PRACH transmission power being greater than the second PRACH transmission power and the first time being greater than the second time. For instance, referring to FIG. 4, at decision 408, the UE may select to transmit RACH preamble 724 in baseline RO 402b based on the power differences 504 and latency differences 502 illustrated in scenario 420.

In one example, the additional RACH occasion may be selected at least in part based on the first PRACH transmission power being greater than the second PRACH transmission power and the first time being greater than the second time. For instance, referring to FIG. 4, at decision 410, the UE may select to transmit RACH preamble 724 in additional RO 404c based on the power differences 504 and latency differences 502 illustrated in scenario 422.

In one example, the RACH occasion decision region may include a boundary defined by a first difference between the first PRACH transmission power and the second PRACH transmission power and a second difference between the first time and the second time. For instance, referring to FIG. 5, baseline RO decision region 508 and additional RO decision region 510 may include boundary 506 defined by power difference 504 and latency difference 502 associated with baseline ROs 402 and additional ROs 404.

In one example, the configuration may include one or more semi-statically configured parameters of a function indicating the RACH occasion decision region. For instance, referring to FIGS. 5 and 7, configuration 708 may include decision function parameter(s) 712 of function 512 indicating the boundary 506 or baseline RO decision region 508 or additional RO decision region 510.

In one example, the configuration may include a fixed or semi-statically configured dataset including a range of values indicating the RACH occasion decision region. For instance, referring to FIGS. 5 and 7, configuration 708 may include decision function dataset 714 indicating the boundary 506 or baseline RO decision region 508 or additional RO decision region 510.

In one example, the selection may further be based on a history of RACH preamble transmissions of the UE. For instance, referring to FIGS. 6 and 7, the selection 514 performed at block 722 may further be based on history 602, such as the transmission powers or latencies associated with prior RACH preamble transmission attempts in baseline ROs 402 and additional ROs 404.

In one example, the selection being further based on the history may include the selection being based at least in part on only the first time and the second time in response to the first PRACH transmission power and the second PRACH transmission power being greater than respective PRACH transmission powers associated with prior RACH occasions. For instance, referring to FIGS. 6 and 7, the selection 514 performed at block 722 further based on history 602 may account for latency differences 502 only, as opposed to both latency differences 502 and power differences 504, in response to the transmission powers 412 or 414 associated with baseline ROs 402 and additional ROs 404 still increasing over time in response to failed RACH attempts.

In one example, the selection being further based on the history may include the selection being further based at least in part on a maximum number of preamble transmissions having been previously sent in association with a RACH occasion type. For instance, referring to FIGS. 6 and 7, the selection 514 performed at block 722 further based on history 602 may account additionally for the case where the UE 704 has previously reached maximum number of preamble transmissions 610 for either baseline ROs 402 or additional ROs 404. For instance, if the UE reached the maximum number of preamble transmissions 610 for additional ROs 404 in history 602 following multiple failed RACH attempts and preamble retransmissions with incremented power, the selection 514 at decision 408 may be further based on power differences 504 as well as latency differences 502 in scenario 604.

In one example, the selection being further based on the history may include the selection of one RACH occasion type being based at least in part on a maximum transmission power having been previously reached in association with a different RACH occasion type. For instance, referring to FIGS. 6 and 7, the selection 514 performed at block 722 further based on history 602 may account additionally for the case where the UE 704 has previously reached the maximum transmission power 606, 608 for either baseline ROs 402 or additional ROs 404. For instance, if the UE reached the maximum transmission power 608 for additional ROs 404 in history 602 following multiple failed RACH attempts and preamble retransmissions with incremented power, the selection 514 at decision 408 may be the fallback, baseline RO 402. The baseline RO 402 may be selected in this case instead of the additional RO 404, for example, either based on power differences 504 as well as latency differences 502 in scenario 604, or notwithstanding power differences 504 or latency differences 502.

In one example, the selection may be further based at least in part on a PRACH configuration or a feature group associated with the RACH occasion and the additional RACH occasion. For instance, referring to FIGS. 6 and 7, the selection 514 performed at block 722 may further account for the PRACH configuration 612 or feature group 614 respectively associated with baseline ROs 402 or additional ROs 404.

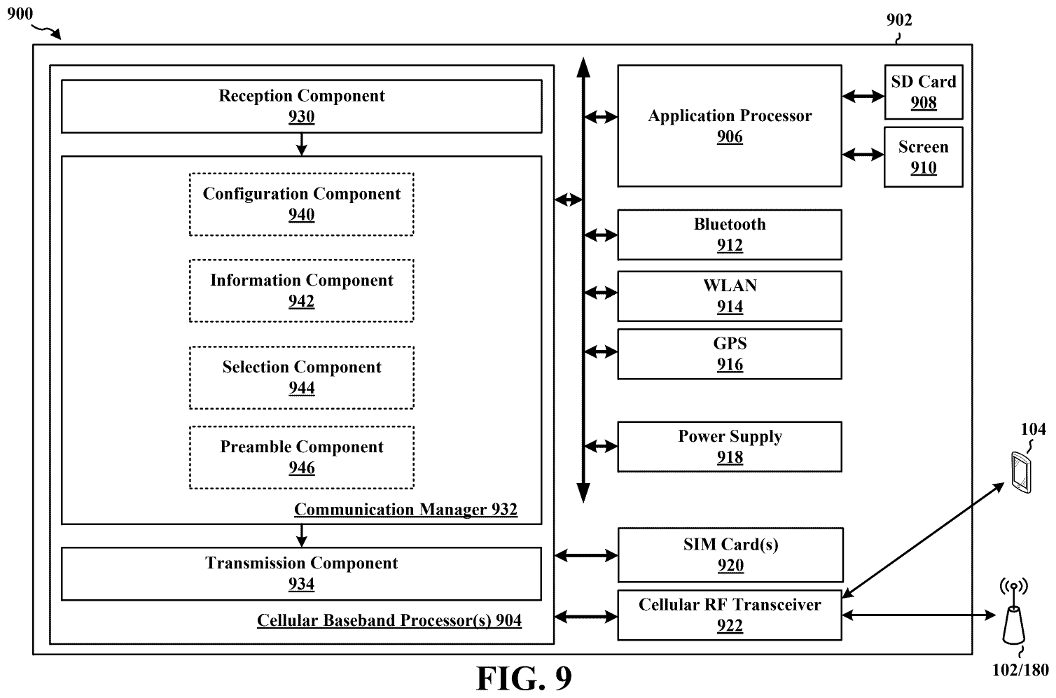

FIG. 9 is a diagram 900 illustrating an example of a hardware implementation for an apparatus 902 according to the various aspects of the present disclosure. In one example, the apparatus 902 may be a UE such as UE 104, 350, 704 and includes one or more cellular baseband processors 904 (also referred to as a modem) coupled to a cellular RF transceiver 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The one or more cellular baseband processors 904 communicate through the cellular RF transceiver 922 with the BS 102 or another UE 104. For example, the cellular RF transceiver 922 may correspond to or include the transmitters 354TX, receivers 354RX, and antennas 352 of UE 350.

The one or more cellular baseband processors 904 may each include a computer-readable medium/one or more memories. The computer-readable medium/one or more memories may be non-transitory. The one or more cellular baseband processors 904 are responsible for general processing, including the execution of software stored on the computer-readable medium/one or more memories individually or in combination. The software, when executed by the one or more cellular baseband processors 904, causes the one or more cellular baseband processors 904 to, individually or in combination, perform the various functions described supra. The computer-readable medium/one or more memories may also be used individually or in combination for storing data that is manipulated by the one or more cellular baseband processors 904 when executing software. The one or more cellular baseband processors 904 individually or in combination further include a reception component 930, a communication manager 932, and a transmission component 934. The communication manager 932 includes the one or more illustrated components. The components within the communication manager 932 may be stored in the computer-readable medium/one or more memories and/or configured as hardware within the one or more cellular baseband processors 904. The one or more cellular baseband processors 904 may be components of the UE 104, 350, 704, and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 930 may correspond to or include the one or more RX processors 356, the communication manager 932 may correspond to or include the one or more controllers/processors 359, and the transmission component 934 may correspond to or include the one or more TX processors 368. In one configuration, the apparatus 902 may be a modem chip and include just the one or more baseband processors 904, and in another configuration, the apparatus 902 may be the entire UE (e.g., UE 350 of FIG. 3) and include the aforediscussed additional modules of the apparatus 902.

The communication manager 932 may include a configuration component 940 that is configured to receive a RACH configuration indicating a RACH occasion, such as described in connection with block 802 of FIG. 8. In one configuration, the configuration component 940 may further be configured to obtain a configuration indicating a RACH occasion decision region for the selection of the one of the RACH occasion or the additional RACH occasion, such as described in connection with block 804 of FIG. 8. The communication manager 932 may further include an information component 942 that is configured to receive information activating an additional RACH occasion, such as described in connection with block 806 of FIG. 8. The communication manager 932 may further include a selection component 944 that is configured to select one of the RACH occasion or the additional RACH occasion for a RACH preamble transmission, the selection being at least in part based on one or more of: a first PRACH transmission power associated with the RACH occasion and a second PRACH transmission power associated with the additional RACH occasion, or a first time associated with the RACH occasion and a second time associated with the additional RACH occasion, such as described in connection with block 808 of FIG. 8. The communication manager 932 may further include a preamble component 946 that is configured to transmit a RACH preamble in the selected one of the RACH occasion or the additional RACH occasion, such as described in connection with block 810 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 902, and in particular the one or more cellular baseband processors 904, includes means for receiving a RACH configuration indicating a RACH occasion, where the means for receiving is further configured to receive information activating an additional RACH occasion, means for selecting one of the RACH occasion or the additional RACH occasion for a RACH preamble transmission, the selection being at least in part based on one or more of: a first PRACH transmission power associated with the RACH occasion and a second PRACH transmission power associated with the additional RACH occasion, or a first time associated with the RACH occasion and a second time associated with the additional RACH occasion, and means for transmitting a RACH preamble in the selected one of the RACH occasion or the additional RACH occasion.

In one configuration, the apparatus 902, and in particular the one or more cellular baseband processors 904, may include means for obtaining a configuration indicating a RACH occasion decision region for the selection of the one of the RACH occasion or the additional RACH occasion.

The aforementioned means may be one or more of the aforementioned components of the apparatus 902 configured to perform the functions recited by the aforementioned means. Moreover, as described supra, the apparatus 902 may include the one or more TX processors 368, the one or more RX processors 356, and the one or more controllers/processors 359. As such, in one configuration, the aforementioned means may be at least one of the one or more TX processors 368, at least one of the one or more RX processors 356, or at least one of the one or more controllers/processors 359, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.
Clause 1. An apparatus for wireless communication, comprising: one or more memories; and one or more processors each communicatively coupled with at least one of the one or more memories, the one or more processors, individually or in any combination, operable to cause the apparatus to: receive a random access channel (RACH) configuration indicating a RACH occasion; receive information activating an additional RACH occasion; select one of the RACH occasion or the additional RACH occasion for a RACH preamble transmission, the selection being at least in part based on one or more of: a first physical RACH (PRACH) transmission power associated with the RACH occasion and a second PRACH transmission power associated with the additional RACH occasion, or a first time associated with the RACH occasion and a second time associated with the additional RACH occasion; and transmit a RACH preamble in the selected one of the RACH occasion or the additional RACH occasion.
Clause 2. The apparatus of clause 1, wherein the selection is based at least in part on a first difference between the first PRACH transmission power and the second PRACH transmission power, and a second difference between the first time and the second time.
Clause 3. The apparatus of clause 2, wherein the first PRACH transmission power is a first actual transmission power of the apparatus or a first calculated transmission power of the apparatus that is different than the first actual transmission power, and the second PRACH transmission power is a second actual transmission power of the apparatus or a second calculated transmission power of the apparatus that is different than the second actual transmission power.
Clause 4. The apparatus of clause 2 or clause 3, wherein the RACH occasion is selected at least in part based on the first PRACH transmission power being greater than the second PRACH transmission power and the first time being lesser than the second time.
Clause 5. The apparatus of clause 2 or clause 3, wherein the RACH occasion is selected at least in part based on the first PRACH transmission power being greater than the second PRACH transmission power and the first time being greater than the second time.
Clause 6. The apparatus of clause 2 or clause 3, wherein the additional RACH occasion is selected at least in part based on the first PRACH transmission power being greater than the second PRACH transmission power and the first time being greater than the second time.
Clause 7. The apparatus of any of clauses 1 to 6, wherein the one or more processors, individually or in any combination, are further operable to cause the apparatus to: obtain a configuration indicating a RACH occasion decision region for the selection of the one of the RACH occasion or the additional RACH occasion, the RACH occasion decision region including a boundary defined by a first difference between the first PRACH transmission power and the second PRACH transmission power and a second difference between the first time and the second time.
Clause 8. The apparatus of clause 7, wherein the configuration includes one or more semi-statically configured parameters of a function indicating the RACH occasion decision region.
Clause 9. The apparatus of clause 7, wherein the configuration includes a fixed or semi-statically configured dataset including a range of values indicating the RACH occasion decision region.
Clause 10. The apparatus of any of clauses 1 to 9, wherein the selection is further based on a history of RACH preamble transmissions of the apparatus.
Clause 11. The apparatus of clause 10, wherein the selection being further based on the history includes: the selection being based at least in part on only the first time and the second time in response to the first PRACH transmission power and the second PRACH transmission power being greater than respective PRACH transmission powers associated with prior RACH occasions.
Clause 12. The apparatus of clause 10 or clause 11, wherein the selection being further based on the history includes: the selection being further based at least in part on a maximum number of preamble transmissions having been previously sent in association with a RACH occasion type.
Clause 13. The apparatus of any of clauses 10 to 12, wherein the selection being further based on the history includes: the selection of one RACH occasion type being based at least in part on a maximum transmission power having been previously reached in association with a different RACH occasion type.
Clause 14. The apparatus of any of clauses 1 to 13, wherein the selection is further based at least in part on a PRACH configuration or a feature group associated with the RACH occasion and the additional RACH occasion.
Clause 15. A method of wireless communication performable at a user equipment (UE), comprising: receiving a random access channel (RACH) configuration indicating a RACH occasion; receiving information activating an additional RACH occasion; selecting one of the RACH occasion or the additional RACH occasion for a RACH preamble transmission, the selection being at least in part based on one or more of: a first physical RACH (PRACH) transmission power associated with the RACH occasion and a second PRACH transmission power associated with the additional RACH occasion, or a first time associated with the RACH occasion and a second time associated with the additional RACH occasion; and transmitting a RACH preamble in the selected one of the RACH occasion or the additional RACH occasion.
Clause 16. The method of clause 15, wherein the selection is based at least in part on a first difference between the first PRACH transmission power and the second PRACH transmission power, and a second difference between the first time and the second time.
Clause 17. The method of clause 15 or clause 16, further comprising: obtaining a configuration indicating a RACH occasion decision region for the selection of the one of the RACH occasion or the additional RACH occasion, the RACH occasion decision region including a boundary defined by a first difference between the first PRACH transmission power and the second PRACH transmission power and a second difference between the first time and the second time.
Clause 18. The method of any of clauses 15 to 17, wherein the selection is further based on a history of RACH preamble transmissions of the UE.
Clause 19. The method of any of clauses 15 to 18, wherein the selection is further based at least in part on a PRACH configuration or a feature group associated with the RACH occasion and the additional RACH occasion.
Clause 20. An apparatus for wireless communication, comprising: means for receiving a random access channel (RACH) configuration indicating a RACH occasion; the means for receiving being further configured to receive information activating an additional RACH occasion; means for selecting one of the RACH occasion or the additional RACH occasion for a RACH preamble transmission, the selection being at least in part based on one or more of: a first physical RACH (PRACH) transmission power associated with the RACH occasion and a second PRACH transmission power associated with the additional RACH occasion, or a first time associated with the RACH occasion and a second time associated with the additional RACH occasion; and means for transmitting a RACH preamble in the selected one of the RACH occasion or the additional RACH occasion.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive a random access channel (RACH) configuration indicating a RACH occasion;
receive information activating an additional RACH occasion;
select one of the RACH occasion or the additional RACH occasion for a RACH preamble transmission, the selection being at least in part based on one or more of:
a first physical RACH (PRACH) transmission power associated with the RACH occasion and a second PRACH transmission power associated with the additional RACH occasion, or
a first time associated with the RACH occasion and a second time associated with the additional RACH occasion; and
transmit a RACH preamble in the selected one of the RACH occasion or the additional RACH occasion.

2. The apparatus of claim 1, wherein the selection is based at least in part on a first difference between the first PRACH transmission power and the second PRACH transmission power, and a second difference between the first time and the second time.

3. The apparatus of claim 2, wherein
the first PRACH transmission power is a first actual transmission power of the apparatus or a first calculated transmission power of the apparatus that is different than the first actual transmission power, and
the second PRACH transmission power is a second actual transmission power of the apparatus or a second calculated transmission power of the apparatus that is different than the second actual transmission power.

4. The apparatus of claim 2, wherein the RACH occasion is selected at least in part based on the first PRACH transmission power being greater than the second PRACH transmission power and the first time being lesser than the second time.

5. The apparatus of claim 2, wherein the RACH occasion is selected at least in part based on the first PRACH transmission power being greater than the second PRACH transmission power and the first time being greater than the second time.

6. The apparatus of claim 2, wherein the additional RACH occasion is selected at least in part based on the first PRACH transmission power being greater than the second PRACH transmission power and the first time being greater than the second time.

7. The apparatus of claim 1, wherein the one or more processors, individually or in any combination, are further operable to cause the apparatus to:
obtain a configuration indicating a RACH occasion decision region for the selection of the one of the RACH occasion or the additional RACH occasion, the RACH occasion decision region including a boundary defined by a first difference between the first PRACH transmission power and the second PRACH transmission power and a second difference between the first time and the second time.

8. The apparatus of claim 7, wherein the configuration includes one or more semi-statically configured parameters of a function indicating the RACH occasion decision region.

9. The apparatus of claim 7, wherein the configuration includes a fixed or semi-statically configured dataset including a range of values indicating the RACH occasion decision region.

10. The apparatus of claim 1, wherein the selection is further based on a history of RACH preamble transmissions of the apparatus.

11. The apparatus of claim 10, wherein the selection being further based on the history includes:
the selection being based at least in part on only the first time and the second time in response to the first PRACH transmission power and the second PRACH transmission power being greater than respective PRACH transmission powers associated with prior RACH occasions.

12. The apparatus of claim 10, wherein the selection being further based on the history includes:
the selection being further based at least in part on a maximum number of preamble transmissions having been previously sent in association with a RACH occasion type.

13. The apparatus of claim 10, wherein the selection being further based on the history includes:
the selection of one RACH occasion type being based at least in part on a maximum transmission power having been previously reached in association with a different RACH occasion type.

14. The apparatus of claim 1, wherein the selection is further based at least in part on a PRACH configuration or a feature group associated with the RACH occasion and the additional RACH occasion.

15. A method of wireless communication performable at a user equipment (UE), comprising:
receiving a random access channel (RACH) configuration indicating a RACH occasion;
receiving information activating an additional RACH occasion;
selecting one of the RACH occasion or the additional RACH occasion for a RACH preamble transmission, the selection being at least in part based on one or more of:
a first physical RACH (PRACH) transmission power associated with the RACH occasion and a second PRACH transmission power associated with the additional RACH occasion, or
a first time associated with the RACH occasion and a second time associated with the additional RACH occasion; and
transmitting a RACH preamble in the selected one of the RACH occasion or the additional RACH occasion.

16. The method of claim 15, wherein the selection is based at least in part on a first difference between the first PRACH transmission power and the second PRACH transmission power, and a second difference between the first time and the second time.

17. The method of claim 15, further comprising:
obtaining a configuration indicating a RACH occasion decision region for the selection of the one of the RACH occasion or the additional RACH occasion, the RACH occasion decision region including a boundary defined by a first difference between the first PRACH transmission power and the second PRACH transmission power and a second difference between the first time and the second time.

18. The method of claim 15, wherein the selection is further based on a history of RACH preamble transmissions of the UE.

19. The method of claim 15, wherein the selection is further based at least in part on a PRACH configuration or a feature group associated with the RACH occasion and the additional RACH occasion.

20. An apparatus for wireless communication, comprising:
means for receiving a random access channel (RACH) configuration indicating a RACH occasion;
the means for receiving being further configured to receive information activating an additional RACH occasion;
means for selecting one of the RACH occasion or the additional RACH occasion for a RACH preamble transmission, the selection being at least in part based on one or more of:
a first physical RACH (PRACH) transmission power associated with the RACH occasion and a second PRACH transmission power associated with the additional RACH occasion, or
a first time associated with the RACH occasion and a second time associated with the additional RACH occasion; and
means for transmitting a RACH preamble in the selected one of the RACH occasion or the additional RACH occasion.
